(19) United States
(12) Patent Application Publication
(10) Pub. No.: US 2009/0303414 A1
(43) Pub. Date: Dec. 10, 2009

(54) OPTICAL MEMBER WITH A SCATTER LAYER, AND BACKLIGHT ASSEMBLY AND DISPLAY DEVICE HAVING THE SAME

(75) Inventors: Seung-Hwan CHUNG, Gyeonggi-do (KR); Jin-Sung CHOI, Chungcheongnam-do (KR); Byung-Yun JOO, Seoul (KR); Sang-Hoon LEE, Chungcheongnam-do (KR); Min-Young SONG, Seoul (KR); Dong-Kwan KIM, Seoul (KR)

Correspondence Address: Haynes and Boone, LLP;IP Section, 2323 Victory Avenue, SUITE 700, Dallas, TX, 75219, US

(73) Assignee: SAMSUNG ELECTRONICS CO., LTD., Gyeonggi-do (KR)

(21) Appl. No.: 12/408,185

(22) Filed: Mar. 20, 2009

(30) Foreign Application Priority Data
Jun. 5, 2008 (KR) 2008-52956

(51) Int. Cl. G02F 1/1335; G02B 5/02; F21V 11/00

(52) U.S. Cl. 349/64; 359/599; 362/97.1

(57) ABSTRACT

A display device includes a backlight assembly including an optical member comprising: a base film; a plurality of linear shaped prisms disposed on the base film and extending in one direction; and a scatter layer underlying the base film and attached to the base film and comprising a coat of beads which is spread under the base film, the scatter layer having a haze value of about 10% to about 30%.

### PRIORITY STATEMENT

This application claims priority under 35 U.S.C. § 119 to Korean Patent Application No. 2008-52956, filed on Jun. 5, 2008 in the Korean Intellectual Property Office (KIPO), the contents of which are herein incorporated by reference in their entirety.

### BACKGROUND OF THE INVENTION

1. Field of the Invention

The present invention relates to an optical member, and a backlight assembly and a display device having the optical member. More particularly, the present invention relates to an optical member capable of exhibiting an improved image display quality, and a backlight assembly and a display device containing the optical member.

2. Description of Related Art

Liquid crystal display (LCD) devices have many good qualities in regard to thickness, durability, weight, power consumption, etc. An LCD device is a type of flat panel display device. The LCD device includes an LCD panel that has two substrates and a liquid crystal layer interposed therebetween. The liquid crystal layer's light transmittance changes in response to an electric field to display a desired image.

The liquid crystal display is a non-emitting device. Therefore, in order to display an image, the liquid crystal display may need an outside light source unit providing uniform illumination of the viewing plane of the liquid crystal panel. Such light source unit is implemented as part of a backlight assembly.

The backlight assemblies may be classified into two types depending on the position of the light source: direct type and edge-light type. In the direct type, the light source is disposed at the back of the liquid crystal panel. In the edge-light type, the light source is disposed along a side surface of a light guide plate.

FIG. 1 is a perspective view of an edge-light type backlight assembly. This backlight assembly 10 comprises a light source unit 1, a reflector sheet 2, a light guide plate 3, and optical sheets 4, 5 and 6.

The light source unit 1 comprises a light source 1a and a light source reflector 1b. The light source 1a is located in a cavity in the light source reflector 1b, and extends along a side surface of the light guide plate 3. The light generated by the light source 1a is reflected by the light source reflector 1b toward the light guide plate 3, thereby improving the light efficiency of the backlight assembly 10.

The light guide plate 3 distributes the light received through the light-incidence side surface of the light guide plate 3. Some of the distributed light is emitted toward the liquid crystal panel (not shown) through the upper, light-emitting surface of the light guide plate 3. Some of the distributed light is emitted through the lower surface of the light guide plate 3 and reflected back by the reflector sheet 2 to reenter the light guide plate 3 and then to exit through the upper surface, thus improving the light efficiency of the backlight assembly 10.

The optical sheets 4, 5 and 6 may be a diffuser sheet 4, a prism sheet 5 and a protector sheet 6. The optical sheets 4, 5 and 6 function as follows.

The light emitted through the upper surface of the light guide plate 3 enters the diffuser sheet 4. The diffuser sheet 4 scatters the light to make the brightness more uniform and widen the viewing angle.

Because the brightness declines sharply as the light passes through the diffuser sheet 4, the prism sheet 5 is provided in the backlight assembly 10 to compensate f the brightness decrease. The light beams arriving from the diffuser sheet 4 at small angles relative to the diffuser sheet are refracted by the prism sheet 5 upward, to travel at higher angles, thereby improving brightness within the effective viewing angle.

FIG. 2 is a cross-sectional view of the prism sheet 5 of FIG. 1 taken along the line I-I′.

Referring to FIG. 2, the prism sheet 5 is comprised of a base film 11 and a plurality of prisms 12 disposed on the base film 11.

Some of the light arriving from the diffuser sheet 4 (FIG. 1) is reflected by the prism sheet 5 back to the diffuser sheet 4, and the remaining light is refracted by the diffuser sheet 4 toward the liquid crystal panel (not shown), thereby improving the brightness within the effective viewing angle.

Referring back to FIG. 1, the protector sheet 6 is disposed over the prism sheet 5. The protector sheet 6 protects the surface of the prism sheet 5 from being damaged, and also widens the viewing angle narrowed by the prism sheet 5.

In the conventional edge-light type backlight assembly, many optical sheets having different optical characteristics are needed, which increases the size and manufacturing cost of the liquid crystal display.

### SUMMARY

This section summarizes some features of the invention. Other features described in subsequent sections. The invention is defined by the appended claims.

Some embodiments of the present invention provide a display device which provides good image display quality without adding any diffuser sheet. The display device can be made thinner due to omission of the diffuser sheet.

Some embodiments provide an optical member includes a base film, a plurality of linear shaped prisms, and a scatter layer. The prisms are disposed on the base film and extend in one direction. The scatter layer underlies the base film and is attached to the base film and includes a coat of beads which is spread under the base film. The scatter layer has a haze value of about 10% to about 30%.

Some embodiments provide a display device including a backlight assembly which includes a light source, an optical plate, first and second optical members, and a liquid crystal panel. The optical plate includes a light incident portion for receiving light from the light source, a light emitting portion for emitting the light outside of the optical plate, and a reflecting portion disposed opposite the light emitting portion, the reflecting portion being for reflecting the light received through the light incident portion. The first optical member is disposed over the light emitting portion and includes a first base film and a plurality of linear shaped prisms. The second optical member is disposed over the first optical member and includes a second base film and a plurality of linear shaped prisms. The first optical member includes a first scatter layer underlying the first base film and attached to the first base film and including a coat of beads which is spread under the first base film, the first scatter layer having a haze value of about 10% to about 30%. The optical plate is positioned in an optical path extending from the light source to the light receiving portion, then to the light emitting portion, and then to the liquid crystal panel.

The invention is defined by the appended claims.

### BRIEF DESCRIPTION OF THE DRAWINGS

FIG. 1 is a perspective view of a backlight assembly for illuminating a liquid crystal panel;

FIG. 2 is a partial cross-sectional view taken along a line I-I′ in FIG. 1;

FIG. 3 is a perspective view illustrating a display device according to an exemplary embodiment of the present invention;

FIG. 4 is a perspective view illustrating a part of the display device illustrated in FIG. 3;

FIG. 5 is a cross-sectional view illustrating a prism sheet according to an exemplary embodiment of the present invention;

FIG. 6 is a graph of a luminance as a function of a user's viewing angle expressed to show the relative position of the light source;

FIGS. 7A, 7B are plan (top) views illustrating possible placements of the light source and two prism sheets according to exemplary embodiments of the present invention.

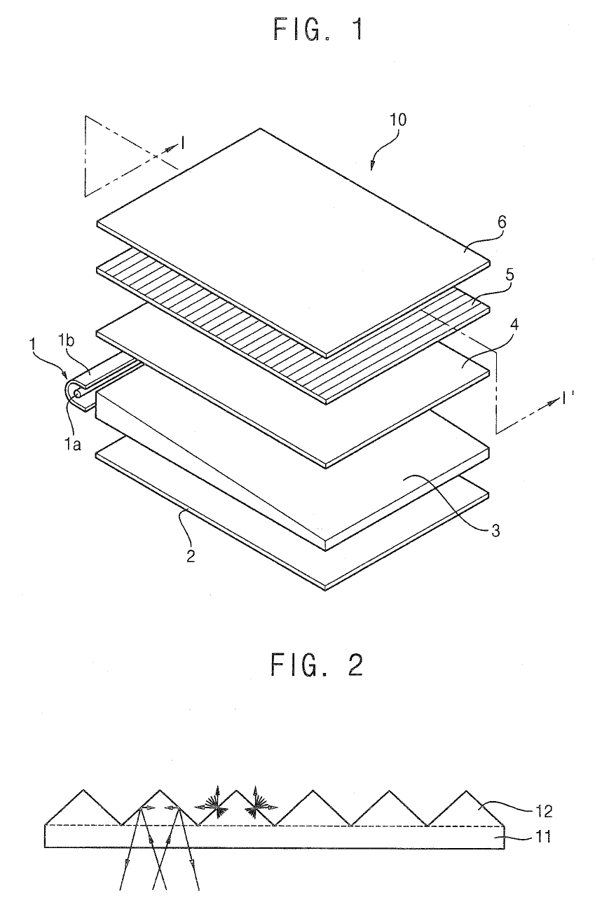

### DETAILED DESCRIPTION OF SOME EMBODIMENTS

Some embodiments of the present invention will now be described with reference to the accompanying drawings. This invention, however, may be embodied in many different forms and should not be construed as limited to embodiments set forth herein. It will be understood that when an element is referred to as being “on” or “onto” another element, it may be directly on the other element or intervening elements may also be present. In contrast, when an element is referred to as being “directly on” another element, there are no intervening elements present. Like reference numerals refer to similar or identical elements throughout.

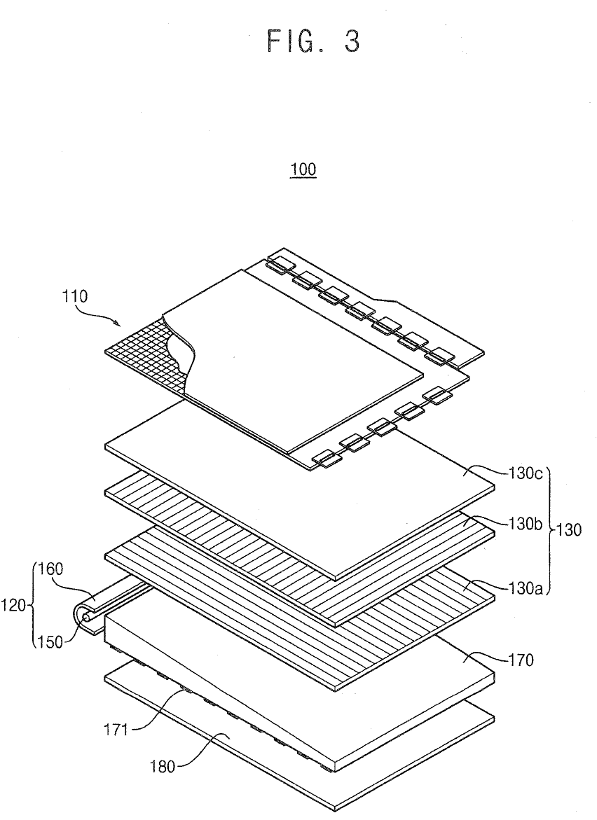

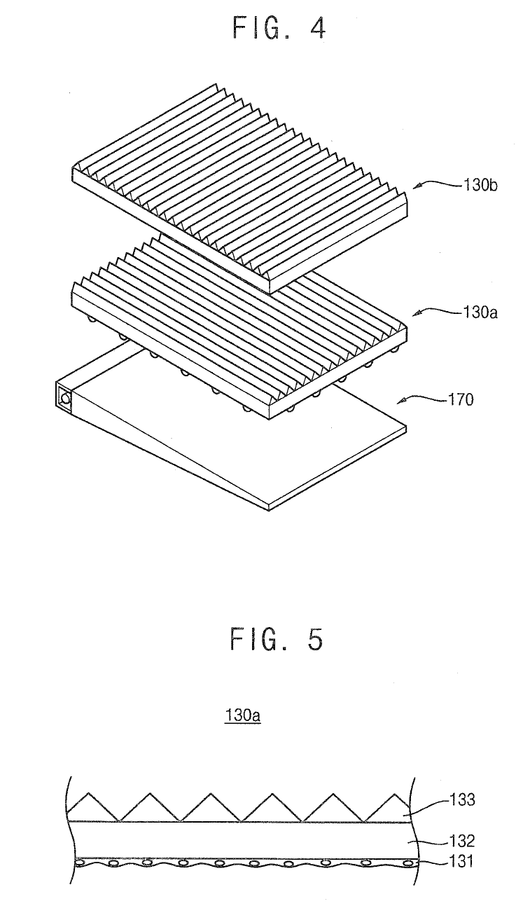

FIG. 3 is a perspective view of a display device 100 according to one embodiment of the present invention, and FIG. 4 is a perspective view illustrating a part of the display device 100 illustrated in FIG. 3.

Referring to FIGS. 3 and 4, the display device 100 comprises a liquid crystal panel 110 for displaying images in response to driving signals and data signals received from external devices (not shown), and also comprises a backlight unit 120 disposed at the back side of the liquid crystal panel 110 and providing light (e.g. white light) to the liquid crystal panel 110.

The backlight unit 120 comprises a light source 150, a light source reflector 160 placed behind the light source 150, a light guide plate 170 receiving light from the light source and emitting the light toward the liquid crystal panel 110, and a set of optical sheets 130 disposed between the light guide plate 170 and the liquid crystal panel 110. The backlight unit 120 is of the edge-light type, with the light source 150 disposed at a side surface (an edge) of the light guide plate 170.

The light source 150 according to one embodiment of the present invention is a linear light source such as a cold cathode fluorescent lamp (CCFL) or an external electrode fluorescent lamp (EEFL). Alternatively, the light source 150 may be a point light source such as a light emitting diode (LED). A plurality of light emitting diodes (LEDs) may be disposed at least on one side of the light guiding plate, along the light incident portion of the light guiding plate.

The light source reflector 160 is disposed behind light source 150. The light source reflector 160 may be made of metal or plastic. The inner surface of the light source reflector 160 may be coated with light reflective materials to reflect the light generated by the light source 150 toward the side surface of the light guide plate 170. Alternatively, and depending on the kind of the light source, the light source reflector 160 may be omitted. For example, if the light source is a light emitting diode (LED), the light source reflector 160 may be omitted.

The light source reflector 160 reflects the light generated by the light source 150 toward the light incidence surface of the light guide plate 170, thereby improving the light efficiency of the backlight unit 120.

The light guide plate 170 distributes the light arriving through the light incidence surface before emitting the light through the light emitting surface. The light is distributed over the viewing plane of the overlying liquid crystal panel 110 by the principle of total reflection. The upper surface of the light guide plate 170 becomes the light emitting surface through which the light is emitted toward the position of the liquid crystal panel 110.

The total reflection is transformed to scattered reflection in order for the light inside the light guide plate 170 to be emitted toward the liquid crystal panel 110. For this purpose, light scattering pattern 171 may be printed on the lower surface of the light guide plate 170 by using dot-printing techniques. Alternatively, a print-less light guiding plate may be used which does not need a printing process. For example, the light scattering pattern can be provided by grooves on a surface of the light guide plate.

The light guide plate 170 may be formed of a transparent acrylate resin such as Polymethyl methacrylate (PMMA).

The reflector sheet 180 is disposed under the light guide plate 170 to re-direct the light emitted through the lower surface of the light guide plate 170 to cause the light to re-enter the light guide plate 170.

The reflector sheet 180 may be manufactured by forming a silver layer on a sheet of SUS, Brass, Al, PET, etc. and coating the silver layer with Ti to prevent thermal damage that may be caused by heat absorption.

Alternatively, the reflector sheet 180 may be obtained by dispersing light-scattering micro-pores in a resin sheet such as PET.

As shown in the FIG. 3, the backlight assembly 120 comprises a set of optical sheets 130 disposed between the light guide plate 170 and the liquid crystal panel 110.

According to some embodiments of the present invention, the optical sheets 130 are a first prism sheet 130a, a second prism sheet 130b and a protector sheet 130c.

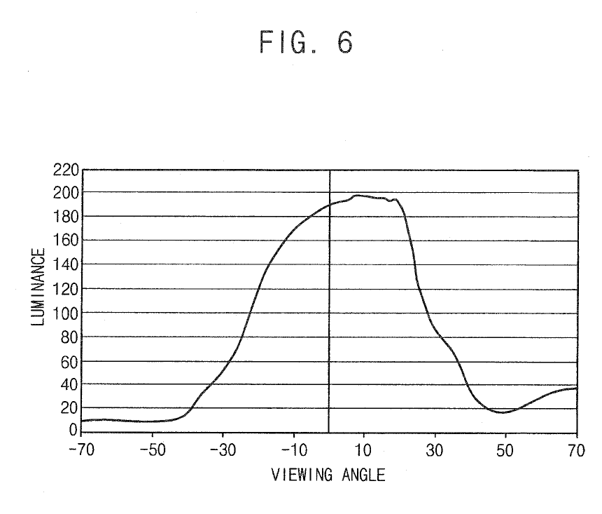

In some embodiments, the backlight assembly 120 does not include a diffuser sheet such as commonly used to obtain uniform illumination of the liquid crystal panel 110. The color dispersion problem is addressed in such embodiments by means of a prism sheet having a scatter layer. More particularly, some embodiments of the present invention include a prism sheet comprising a scatter layer on the lower surface of a base film. Color dispersion problems will be described in detail with reference to the FIG. 6.

Referring back to FIG. 3, the protector sheet 130c may be placed over the second prism sheet 130b to protect the surface of the second prism sheet 130b from damage and to re-widen the viewing angle narrowed by the first and second prism sheets 130a, 130b. In some embodiments, the protector sheet 130c is not a separate sheet but is formed integrally with the second prism sheet 130b.

The invention is not limited to any specific structure or material composition of the protector sheet 130c. Known structures other than described above and known materials can be used.

The first and second prism sheets 130a, 130b may each have the structure and composition of an exemplary prism sheet shown in cross section in FIG. 5. More particularly, each of the first and second prism sheets 130a, 130b may comprise a scatter layer 131, base film 132, and a plurality of prisms 133 disposed on the base film. In the embodiment of FIG. 5, the prisms are linear and parallel to each other.

The scatter layer 131 includes a coat of beads on the lower surface of the base film. The scatter layer 131 helps suppress color dispersion and improve the image quality of the display device.

Although not intending to be bound by theory, one possible reason as to why the color dispersion occurs.

The color dispersion occurs because the prism material has different refractive indices for different wavelengths, e.g. for the red, green and blue wavelengths. Due to the different refractive indices, the maximum viewing angle is different for different wavelengths. Further, as a user's viewing angle (as defined by the user's eyes' position) changes, the luminances of different wavelengths do not change uniformly. If the luminances change gently with the user's viewing angle, then the color dispersion is minimal and is not a problem. However, the color dispersion is a severe problem if the luminance changes abruptly for some wavelengths. FIG. 6 is a graph showing a typical luminance (at some exemplary wavelength) as a function of the user's viewing angle whose sign (positive or negative) defines the relative position of the light source 150. The negative angles correspond to viewing the image from the side of the light source 150 (from the “light-incident side”). The positive angles correspond to viewing the image from the side opposite to the light source 150 (from the “light-emitting” side). When the user's viewing angle is between −30 to −20, the luminance slope with respect to the user's viewing angle is 6.7. When the user's viewing angle is between +20 to +30, the luminance slope is 10.3. Thus, the luminances change abruptly on the light-emitting side. As a result, and due to the mutually perpendicular prism positioning of the first and second prism sheets 130a, 130b (as shown in FIG. 5), the color dispersion can be visible as an “X” shape from the light-emitting side of the display panel.

According to some embodiments of the present invention, the color dispersion is reduced or eliminated due to the bead coating in layer 131 on the bottom of the lower prism sheet 130a or possibly on the bottom of each of the lower and upper prism sheets 130a, 130b. The coating of beads can be provided under the base film in one or both of the prism sheets.

In some embodiments of the present invention, the scatter layer is provided only in the first prism sheet 130a, which is disposed near the light guiding plate 170.

Table 1 shows the luminance and the presence or absence of the color dispersion for different haze values and average diameters of the beads of the scatter layer. In Table 1, the “lower” prism sheet is the first prism sheet 130a, and the “upper” prism sheet is the second prism sheet 130b.

TABLE 1

| | | Average | Lumi- | |
|---|---|---|---|---|
| Embodi- | | diameter | nance | Color |
| ment | Haze value (%) | (μm) | (%) | dispersion |
| 1 | 12 (lower prism sheet only) | 5 | 100 | None |
| 2 | 21 (lower prism sheet only) | 3 | 98.2 | None |
| 3 | 12/21 (lower/upper prism | 5/3 | 95.6 | None |
| | sheet) | | | |
| 4 | 15 (lower prism sheet only) | 10 | 99.5 | Yes |
| 5 | 15/15 (lower/upper prism | 10 | 98.5 | Yes |
| | sheet) | | | |
| 6 | 33 (lower prism sheet only) | 3 | 89.6 | None |
| 7 | 8 (lower prism sheet only) | 5 | 100.7 | Yes |

Generally, when the haze value of the scatter layer is under about 10% (embodiment 7), then color dispersion is visible. On the other hand, when the haze value of the scatter layer is above about 30% (embodiment 6), the luminance is significantly reduced.

More particularly, there is no color dispersion when the haze value of the lower prism sheet is about 12% (embodiments 1, 3); however, there is color dispersion when the haze value of the lower prism sheet is about 8% (embodiment 7). Therefore, the color dispersion problem is not believed to be solved when the haze value of the scatter layer is below about 10%. Further, as seen from the data for embodiment 2, the luminance is about 98.2% when the haze value of the lower prism sheet is about 21%; in contrast (embodiment 6), the luminance is about 89.6%, when the haze value of the lower prism sheet is about 33%. Therefore, the luminance degradation becomes large when the haze value of the scatter layer is above about 30%.

The haze value of the scatter layer should therefore preferably be in the range of about 10% to about 30%.

Table 1 also shows that the color dispersion is negatively affected by a large bead diameter in the scatter layer. In embodiments 4 and 5, even though the haze value of the scatter layer is above about 10%, the average diameter of the beads of the scatter layer is about 10 μM, and the color dispersion is present. The color dispersion is present when the average bead diameter is above about 7 μm. Lower bead diameter is therefore preferable. On the other hand, a very small bead diameter is undesirable for the following reason. The beads can be used to prevent close adhesion between the prism sheet carrying the beads and the underlying surface. Close adhesion is undesirable because it is usually non-uniform and may produce visible patterns on the display screen. However, very small beads, of a diameter under about 1 μm, are ineffective in preventing such adhesion. Therefore, the average diameter of the beads of the scatter layer should preferably be about 1 μm to about 7 μm.

The thickness of the scatter layer may vary widely depending on the bead diameter. Preferably, the thickness of the scatter layer is about 1 μm to about 10 μm. When the thickness of the scatter layer is under about 1 μm, close adhesion between the scatter layer and the underlying prism sheet or light guiding plate may occur. On the other hand, when the thickness of the scatter layer is above about 10 μm, the luminance is reduced and thus the light efficiency is reduced.

The beads distributed in the scatter layer may have a spherical shape and be made of any one or more of the PolyMethylMethacrylate (PMMA), PolyStyrene, PolyCarbonate, PolyUrethane, Nylon, Poly Olefin, Silicon (Si), Silicone. The beads dispersed in the scatter layer reduce the rate of change of the luminance as a function of the user's viewing angle and thus reduce the color dispersion, and the beads can be made of various materials with various refractive indexes.

Disadvantageously, in a backlight assembly without a diffuser sheet a moiré pattern may be created. The moiré pattern problem can be reduced by suitable rotational orientation of the upper and lower prism sheets with respect to the light source (a linear lamp for example). Preferably, the upper and lower prism sheets are disposed so that the axis of the upper prism sheet (the direction of the prisms' ridges) is perpendicular to the axis of the lower prism sheet. Further, the axes of the first and the second prism sheets may be oblique relative to the linear lamp. In some embodiments, the lower prism sheet's axis forms an angle of +45 to +135 degrees with the lamp, and the upper prism sheet's axis forms an angle of −45 to +45 degrees with the lamp. For example, the lower prism sheet's axis may be at +95 degrees to the lamp, and the upper prism sheet's axis at +5 degrees to the lamp so that the axes of the upper and lower prism sheets are perpendicular to each other.

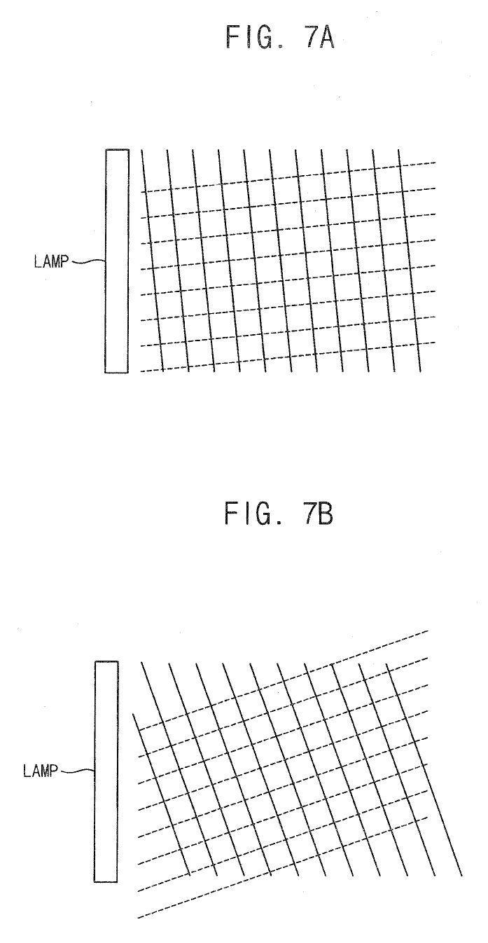

FIGS. 7A, 7B are plan views (top views) illustrating possible relative positions of the lamp, the lower prism sheet 130a, and the upper prism sheet 130b to solve the moiré pattern problem. In FIGS. 7A and 7B, the prisms' ridges of the upper prism sheet are shown by solid lines, and the prisms' ridges of the lower prism sheet by dashed lines.

In FIG. 7A, the angle between the lower prism sheet's axis and the lamp is +95 degrees, and the angle between the upper prism's axis and the lamp is +5 degrees. In FIG. 7B, the angle between the lower prism sheet's axis and the lamp is +70 degrees, and the angle between the upper prism sheet's axis and the lamp is +20 degrees. These geometries suppress (and may completely eliminate) the moiré pattern and improve the light efficiency.

As described above, some embodiments of the present invention provide good display quality with a small number of optical sheets since there is no diffuser sheet. Good display quality is provided due to the use of the scatter layer in a prism sheet. Therefore, the display device can be made thinner and the manufacturing cost can be reduced compared to a conventional display device using a diffuser sheet.

The exemplary embodiments described above illustrate by do not limit the invention. Other embodiments and variations are within the scope of the invention, as defined by the appended claims.

What is claimed is:

1. An optical member comprising:
a base film;
a plurality of linear shaped prisms disposed on the base film and extending in one direction; and
a scatter layer underlying the base film and attached to the base film and comprising beads dispersed under the base film, the scatter layer having a haze value of about 10% to about 30%.

2. The optical member of claim 1, wherein the beads' average diameter is about 1 μm to about 7 μm.

3. The optical member of claim 2, wherein the beads are made of one or more of a group consisting of PolyMethylMethacrylate (PMMA), PolyStyrene, PolyCarbonate, PolyUrethane, Nylon, Poly Olefin, Silicon (Si), and Silicone.

4. The optical member of claim 1, wherein the thickness of the scatter layer is about 1 μm to about 10 μm.

5. A backlight assembly comprising:
a light source;
an optical plate comprising a light incident portion for receiving light from the light source, a light emitting portion for emitting the light outside of the optical plate, and a reflecting portion disposed opposite the light emitting portion, the reflecting portion being for reflecting the light received through the light incident portion;
a first optical member disposed over the light emitting portion and comprising a first base film and a plurality of linear shaped prisms; and
a second optical member disposed over the first optical member and comprising a second base film and a plurality of linear shaped prisms,
wherein the first optical member comprises a first scatter layer underlying the first base film and attached to the first base film and comprising beads dispersed under the first base film, the first scatter layer having a haze value of about 10% to about 30%.

6. The backlight assembly of claim 5, wherein the light source is disposed adjacent to the light incident portion of the optical plate.

7. The backlight assembly of claim 6, wherein the optical plate comprises light scattering patterns on the reflecting portion.

8. The backlight assembly of claim 5, wherein the beads' average diameter is about 1 μm to about 7 μm.

9. The backlight assembly of claim 8, wherein the beads are made of one or more of a group consisting of Poly Methyl Methacrylate (PMMA), Poly Styrene, Poly Carbonate, Poly Urethane, Nylon, Poly Olefin, Silicon (Si), and Silicone.

10. The backlight assembly of claim 5, wherein the thickness of the first scatter layer is about 1 μm to about 10 μm.

11. The backlight assembly of claim 9, wherein the second optical member further comprises a second scatter layer underlying the second base film and attached to the second base film and comprising a coat of beads which is spread under the second base film, the second scatter layer having a haze value of about 10% to about 30%.

12. The backlight assembly of claim 5 further comprising a protector sheet disposed over the second optical member, for protecting the second optical member from damage.

13. The backlight assembly of claim 5 further comprising a reflector sheet disposed under the optical plate, the reflector sheet being for reflecting light leaked from the optical plate and re-directing the leaked light back into the optical plate.

14. The backlight assembly of claim 5, wherein the first optical member's prisms' ridges are substantially perpendicular to the second optical member's prisms' ridges.

15. A display device comprising the backlight assembly of claim 5 in combination with a liquid crystal panel, wherein the optical plate is positioned in an optical path extending from the light source to the liquid crystal panel.

16. The display device of claim 15, wherein the light source is disposed adjacent to the light incident portion of the optical plate.

17. The display device of claim 16, wherein the optical plate comprises light scattering patterns on the reflecting portion.

18. The display device of claim 15, wherein the beads' average diameter is about 1 μm to about 7 μm.

19. The display device of claim 18, wherein the beads are made of one or more of a group consisting of PolyMethylMethacrylate (PMMA), PolyStyrene, PolyCarbonate, PolyUrethane, Nylon, Poly Olefin, Silicon (Si), and Silicone.

20. The display device of claim 15, wherein the thickness of the first scatter layer is about 1 μm to about 10 μm.
